(19) United States
(12) Patent Application Publication
(10) Pub. No.: US 2010/0305483 A1
(43) Pub. Date: Dec. 2, 2010

(54) ADULT TOY

(76) Inventor: Rick Robert Werdt, Harrisburg, PA (US)

Correspondence Address: Rick R. Werdt, 6820 Parkway East, Harrisburg, PA, 17112, US

(21) Appl. No.: 12/775,275

(22) Filed: May 6, 2010

Related U.S. Application Data
(60) Provisional application No. 61/183,445, filed on Jun. 2, 2009.

(51) Int. Cl. A61H 1/00

(52) U.S. Cl. 601/46

(57) ABSTRACT

An apparatus may comprise a main element having a U shape including a first portion corresponding to a first leg of the U shape and a second portion corresponding to a second leg of the U shape, and the first portion having an end portion bent inwards at an angle.

### CROSS-REFERENCE TO RELATED APPLICATIONS

The present application claims the benefit of U.S. Provisional Patent Application No. 61/183,445, filed on Jun. 2, 2009, which is incorporated herein by reference in its entirety.

### BACKGROUND OF THE INVENTION

The present invention generally relates to an adult toy, and more specifically relates to an adult toy that transmits vibrations and provides deep, full, and complete genital stimulation.

### SUMMARY OF THE INVENTION

In one aspect of the present invention, an apparatus may comprise a main element having a U shape including a first portion corresponding to a first leg of the U shape and a second portion corresponding to a second leg of the U shape, and the first portion having an end portion bent inwards at an angle.

In another aspect of the present invention, a method for using an adult toy, the method may comprise inserting a first portion of a main element having a U shape into a vagina of a user, the main element comprising the first portion corresponding to a first leg of the U shape and a second portion corresponding to a second leg of the U shape, the first portion including an end portion bent inwards at an angle; attaching a vibrating toy to the second portion of the main element; and pivoting the vibrating toy to vary pressure exerted by the vibrating toy on a clitoral area of the user.

These and other features, aspects and advantages of the present invention will become better understood with reference to the following drawings, description and claims.

### BRIEF DESCRIPTION OF THE DRAWINGS

FIG. 1 shows a perspective view of an adult toy in accordance with an embodiment of the present invention; and

FIG. 2 shows a cross sectional view of the adult toy of FIG. 1 in use in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an adult toy that may be operable to transmit vibrations to the urethral sponge without blocking fluid release. The adult toy may be slim and small and may be insert-able into a vagina in order to transmit vibrations via an attached vibrating toy to the clitoral area of the user.

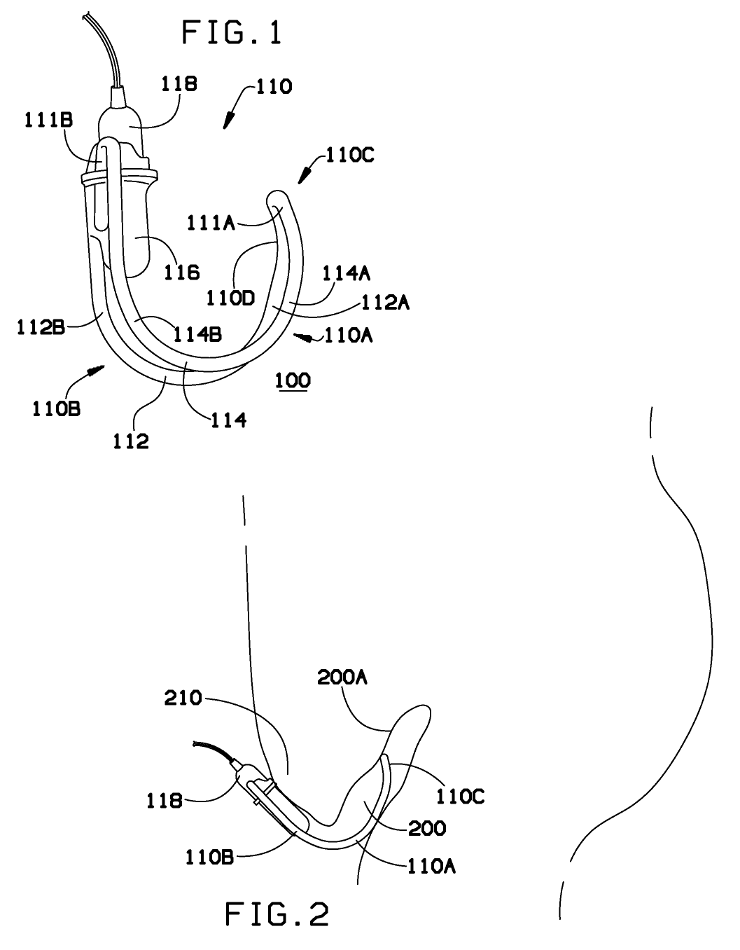

With reference to FIG. 1, an adult toy 100 may comprise a main element 110 having a U shape. The main element 110 may have a first portion 110a corresponding to a first leg of the U shape and a second portion 110b corresponding to a second leg of the U shape. Further, the first portion 110a of the main element 110 may have a hooked end portion 110c that may be bent inwards at an angle 110d.

In accordance with an exemplary embodiment of the present invention, the main element 110 may be an elongated metal wire, tube, or rod, that may be bent at about its midpoint to form a U-shape having a closed end 111a, an open end 111b, and a pair of rails 112 and 114 that may run substantially parallel to each other extending from the closed end 111a to the open end 111b. The pair of rails 112 and 114 may each be bent in parallel with each other to form a U shape, so that the pair of rails 112 and 114 may be divided into first portions 112a and 114a corresponding with the first portion 110a of the main element 110, and second portions 112b and 114b that corresponds with the second portion 110b of the main element 110, respectively. The main element 110 may also comprise the hooked end portion 110c at the closed end 111 a of the main element 110 that may be bent at about a 105° angle 110d from the rest of the main element 110 to form a gentle hook. The hooked end portion 110c may also be situated so that it may be a part of the first portions 112a and 114a of the rails 112 and 114. In alternative embodiments of the present invention, the hooked end portion 110c may include a ball.

In accordance with an exemplary embodiment of the present invention, the main element 110 may be an anti-bacterial and anti-corrosive polished solid copper wire approximately 0.2 inches in diameter and approximately 15 inches in length. The main element 110 may be insulated in its entirety, or a portion of the pair of rails 112 and 114 near the open end 111b may be insulated while the rest of the main element 110 may remain bare metal. The pair of rails 112 and 114 may be separated by approximately 1 inch at the open end 111b while the hooked end portion 110c may be approximately 1.5 inches in length. In addition, the main element 110 and other components of the adult toy 100 may be of any other suitable size.

The adult toy 100 may be used in conjunction with a vibrating egg 118 or any other appropriate vibrating toy. The vibrating egg 118 may be a variable speed vibrator or may have a single vibrating speed. The vibrating egg 118 may be inserted into the open end 111b of the main element 110 and be secured between the pair of rails 112 and 114, such as via a fastening device (not shown). Alternatively, an egg holder 116 may be operable to accept and hold the vibrating egg 118 and may be connected to the main element 110 between the pair of rails 112 and 114 at the open end 111b. The egg holder 116 may be pivotable towards and away from the closed end 111a, so that a user of the adult toy 100 may be able to vary the pressure applied by the vibrating egg 118 to the clitoral area. The main element 110 may be operable to transmit any vibrations caused by the vibrating egg 118, and any such vibrations may be transmitted down the pair of rails 112 and 114.

With reference to FIG. 2, the adult toy 100 may be used to stimulate the genital area of a user, such as a female user, also the adult toy 100 may also be usable by male users. The first portion 110a of the main element 110 including the hooked end portion 110c may be inserted into the vaginal cavity 200 of a user so that the hooked end portion 110c of the main element 110 may be placed on the para-urethral gland/g-spot 200a of the user. When the hooked end portion 110c is placed on the para-urethral gland 200a of the user, the front portions 112a and 114a of the rails 112 and 114 may be situated so that they may rest on the sides of the vaginal cavity 200. With the first portion 110a inserted into the vaginal cavity 200, the second portion 110b of the main element 110 may be situated outside of the vaginal cavity 200 near the clitoral area 210 of the user. The vibrating egg 118 may be turned on and secured to the adult toy 100, such as by inserting the vibrating egg 118 into the egg holder 116. The egg holder 116 may be pivoted to adjust the pressure exerted by the egg holder 116 and the vibrating egg 118 on the clitoral area 210 of the user.

As the vibrating egg 118 vibrates, any vibrations emanating from the vibrating toy 118 may be transmitted down the pair of rails 112 and 114, and may thereby provide stimulation to the clitoral area 210 and the vaginal cavity 200. The vibrations may travel down the pair of rails 112 and 114 to the hooked end portion 110c, and the vibrations may be concentrated at the hooked end portion 110c of the main element 110. Because the adult toy 100 may use a conductive vibration approach with a single vibrating egg 118 instead of a dual motor harmonic resonance approach, the adult toy 100 may not need for additional wires, motors, or electrical current flow within a body cavity. Thus, the current approach of the adult toy 100 may be safer to use by minimizing the risk of electrical shock.

The vaginal cavity 200 of the user should be moist before the adult toy 100 is inserted into the vaginal cavity 200. If desired, personal lubricants may be applied within the vaginal cavity 200 before use of the adult toy 100.

The U shape of the main element 110 as well as the elongated metal wire, tube, or rod that may make up the main element 110 may help to ensure that the vaginal cavity 200, the urethral orfice, and any fluid released from the vaginal cavity 200 and/or the urethral orfice are not obstructed when the adult toy 100 is inserted into the vaginal cavity 200.

It should be understood, of course, that the foregoing relates to exemplary embodiments of the invention and that modifications may be made without departing from the spirit and scope of the invention as set forth in the following claims.

We claim:

1. An apparatus comprising
a main element having a U shape including a first portion corresponding to a first leg of the U shape and a second portion corresponding to a second leg of the U shape, and the first portion having an end portion bent inwards at an angle.

2. The apparatus of claim 1, wherein the main element comprises an elongated rod bent about a midpoint to form a structure having a closed end, an open end, and a pair of rails,
each of the pair of rails bent to form the U shape, and
each of the pair of rails bent at the angle inwards near the closed end.

3. The apparatus of claim 2, wherein the open end is operable to accept and secure a vibrating toy to the main element, and wherein the main element is operable to transmit vibrations from the vibrating toy to the main element.

4. The apparatus of claim 2, further comprising:
a toy holder connected to the main element near the open end and operable to hold a vibrating toy.

5. The apparatus of claim 4, wherein the toy holder is connected to the pair of rails.

6. The apparatus of claim 5, wherein the toy holder is pivotable towards and away from the closed end of the main element.

7. The apparatus of claim 1, wherein the angle may be about 105°.

8. The apparatus of claim 2, wherein the elongated rod is bent to form the U-shape structure.

9. A method for using an adult toy, the method comprising:
inserting a first portion of a main element having a U shape into a vagina of a user, the main element comprising the first portion corresponding to a first leg of the U shape and a second portion corresponding to a second leg of the U shape, the first portion including an end portion bent inwards at an angle;
attaching a vibrating toy to the second portion of the main element; and
pivoting the vibrating toy to vary pressure exerted by the vibrating toy on a clitoral area of the user.

10. The method of claim 9, further comprising:
turning on the vibrating toy.
